(19) United States
(12) Patent Application Publication
(10) Pub. No.: US 2014/0201009 A1
(43) Pub. Date: Jul. 17, 2014

(54) DYNAMIC PRICING FOR GUARANTEED ONLINE DISPLAY ADVERTISING

(71) Applicant: YAHOO! INC., Sunnyvale, CA (US)

(72) Inventors: Jian Yang, Palo Alto, CA (US); Michael Schwarz, Berkeley, CA (US); Vijay Bharadwaj, Sunnyvale, CA (US); Peiji Chen, Saratoga, CA (US)

(73) Assignee: YAHOO! INC., SUNNYVALE, CA (US)

(21) Appl. No.: 13/739,129

(22) Filed: Jan. 11, 2013

(51) Int. Cl. G06Q 30/02

(52) U.S. Cl. CPC G06Q 30/0273
USPC 705/14.69

(57) ABSTRACT

A system and method for dynamic pricing in a guaranteed display market includes: receiving attribute parameters and values for an incoming pricing query for an advertisement; calculating a base price for the advertisement using recent historical information from contracts matching the attribute parameters; calculating a price response by adjusting the base price to reflect market conditions; calculating a non-guaranteed display opportunity cost for the adjusted base price; and calculating a final price as a function of the adjusted base price and the non-guaranteed display opportunity cost, with the non-guaranteed display opportunity cost as a lower bound for the price.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of on-line advertising, and more particularly relates to the field of on-line display advertising.

### BACKGROUND OF THE INVENTION

In guaranteed display (GD) online advertising, the inventory (user visits) is organized in a high-dimensional attribute space, including property, position, targets, and the like. A pricing query can contain many attributes, with the possible permutations of those attributes numbering in the billions. Attributes can be organized in different dimensions. The major dimensions include property (e.g., finance, mail, sports . . . there are thousands), position (LREC, N, SKY . . . tens), gender (m/f), age group (tens), location (country, state, city, zip, . . . , thousands), behavior targeting (thousands), to name a few.

An advertiser can potentially submit a query for the price of any one of these possible attribute combinations. Due to the large number of combinations of attribute values, it is almost impossible for a publisher to set an advertisement price that accurately reflects the query. Instead, a publisher typically only sets the price periodically for major basic inventory profiles (untargeted major properties and positions) and adds simple mark-ups for targets separately. The frequency and granularity of on-line pricing are severely limited.

There is a need for a system and method to overcome these shortcomings of the known art.

### SUMMARY OF THE INVENTION

Briefly, according to an embodiment of the invention a method for dynamic pricing in a guaranteed display market includes steps or acts of: receiving attribute parameters and values for an incoming pricing query for an on-line advertisement; calculating a base price for the advertisement using recent historical information from contracts matching the attribute values; calculating a price response by adjusting the base price to reflect market conditions; calculating a non-guaranteed display opportunity cost for the adjusted base price; and calculating a final price as a function of the adjusted base price and the non-guaranteed display opportunity cost, with the non-guaranteed display opportunity cost as a lower bound for the final price.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system configured to operate according to an embodiment of the present invention;

FIG. 2 is a flowchart of a method according to an embodiment of the invention;

FIG. 3 is a simplified diagram of a computer device configured to operate according to an embodiment of the present invention; and

FIG. 4 is a simplified diagram of the dynamic pricing architecture after receiving a pricing request, according to an embodiment of the present invention;

FIG. 5A shows a list of notations that factor into determining a base price, according to an embodiment of the present invention; and

FIG. 5B shows the formulas used to calculate base price.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

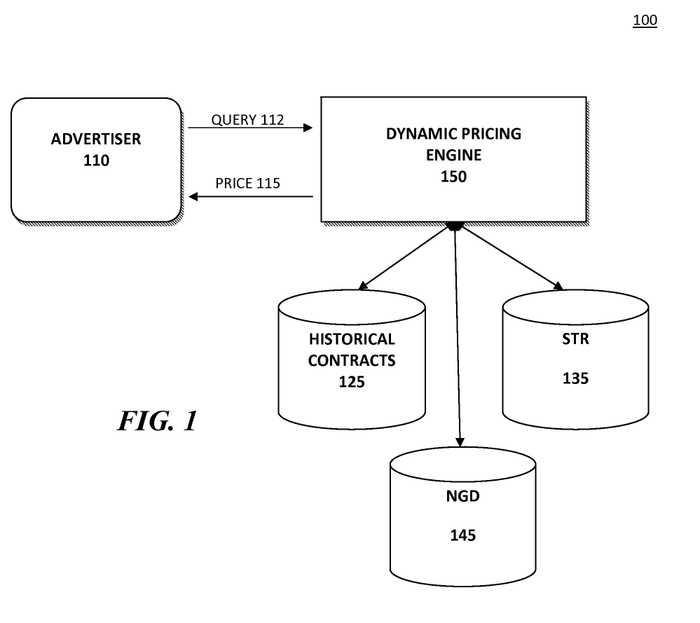

Referring now in detail to the drawings and to FIG. 1 in particular, we show a simplified illustration of a dynamic pricing system 100 in which the present invention is likely to be implemented. The Dynamic Pricing Engine 150 receives a pricing query 112 from an Advertiser 110 and returns a price 115 for an advertisement (Ad) at a granular level that matches the level of granularity of the pricing query 112. In order to calculate the price 115 of the on-line advertisement, the Dynamic Pricing Engine 150 must retrieve data from at least one data store. Three data stores are shown here: Historical Contracts are kept in data store 125 and STR (Sell-Through-Rate) data is kept in data store 135. The third data store 145 is used for Non-Guaranteed Delivery (NGD) forecasting. It will be apparent to those with knowledge in the art that the data stores shown here can be combined into one or two data stores, and remain within the spirit and scope of the invention.

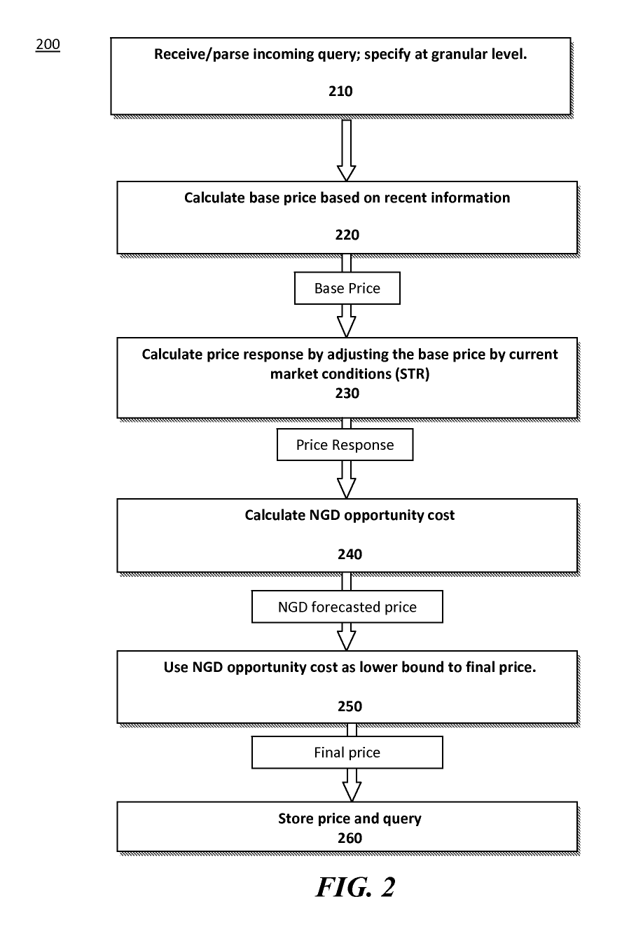

Referring now to FIG. 2, we discuss a flowchart 200 of a dynamic pricing methodology that overcomes the above-stated shortcomings of the known art. First in step 210 we receive an incoming pricing query 112 from an Advertiser 110. The query 112 contains a combination of attribute values defining the property (advertisement), its position, and its target audience. We parse the query 112 to retrieve the attribute values. An example of a query is: PageCategory=Sports, Gender=Male, Location=California, Duration=[27 Jul. 2012-12 Aug. 2012].

We then commence dynamically calculating a price 115 for the advertiser using a method that combines: a historical price, seasonality trends (both current and future), conditions of the GD market, and opportunity cost at the (non-guaranteed display) NGD market. Seasonal trends can affect pricing in both negative and positive terms. For example, at the end of summer, the sale of school supplies generally peak; whereas the sale of patio furniture declines. Taking seasonal trends into account involves: 1) first identifying the time period during which the ad will run; 2) identifying any marketing seasons encompassed by that time period (such as holiday seasons, back-to-school season, swimsuit season, sweater season, and the like); and 3) identifying any marketing seasons that will occur either just before or just after the time period.

The query 112 can be specified at any possible granular level and we calculate the price 115 at the same level of granularity based on the most recent information. Some examples of pricing queries at different levels of granularity are:

PageCategory=Sports, Gender=Male, Age=20-30, Location=California, Duration=[27 Jul. 2012-12 Aug. 2012].

PageCategory=Olympics, Gender=Male, Age=20-30, Location=California, Interest=Travel, Duration=[27 Jul. 2012-12 Aug. 2012].

PageCategory=Olympics, Gender=Male, Age=20-30, Location=BayArea, Interest=Travel AND Finance, Duration=[27 Jul. 2012-12 Aug. 2012].

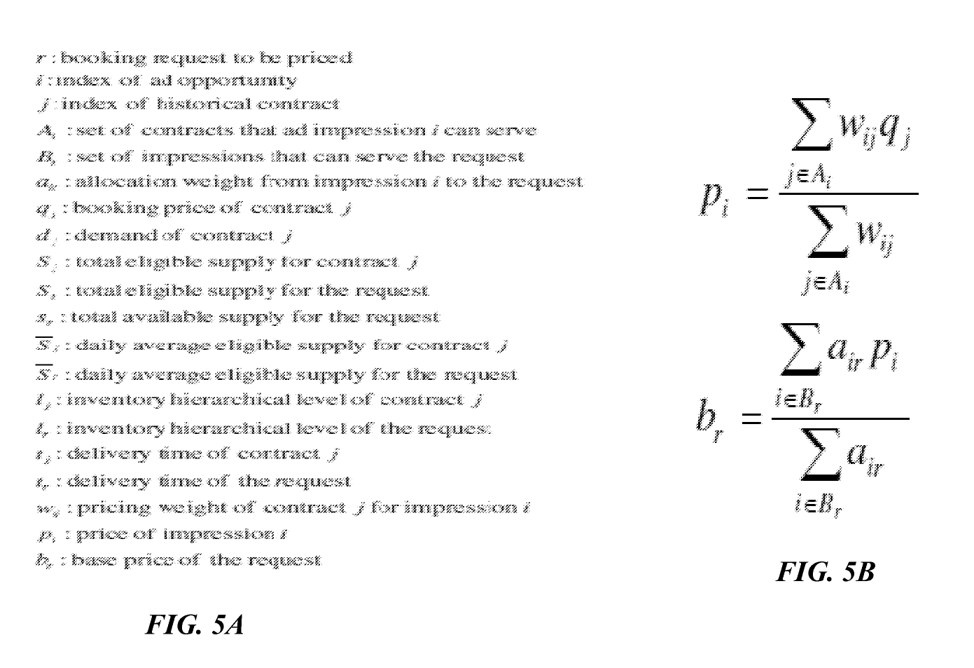

Once we have parsed the query 112, in step 220 we calculate the base price based on historical contracts that are similar to the pricing request 112. The similarity is measured in terms of the distance in the high-dimensional attribute space, meaning that we try to match the query attributes to the contract attributes. The base price of a contract can be viewed as the market prevailing price or price of business as usual, i.e., the price that should be charged for the pricing request if all market conditions remain the same. When there are changes to the market conditions, however, the price should be adjusted accordingly. The base price represents the basic value of impressions that are expected to be delivered to the contract. The basic value of an individual impression in turn can be inferred from the final booked prices of historical contracts that would be able to be delivered by the impression. An impression is an instance that an ad is displayed, whether it is clicked on or not. FIG. 5A shows a list of notations that factor into determining a base price and FIG. 5B shows the formulas used to calculate base price.

Once we have the base price in step 230 we calculate price response by adjusting the base price to current market conditions that are monitored closely through the STR (Sell-Through-Rate) of similar ads. Next we calculate the NGD opportunity cost in step 240. GD contracts are typically booked weeks to months ahead of delivery time. Any inventory that is not booked at the delivery time is normally sold to the NGD market using real-time auction. The price of an impression at the NGD market can thus be viewed as the opportunity cost of the GD market. The NGD opportunity cost for a pricing query is calculated based on a forecasted NGD price of each impression sample. NGD price forecasting is beyond the scope of this disclosure. In step 250 the forecasted price from the NGD market is used as a lower bound to the final price 115 for the GD market that is provided to the Advertiser 110. The final price 115 is computed as the minimum between the STR adjusted base price and the forecasted NGD opportunity cost. We then store the final price 115, along with the query, in step 260.

Some of the features of the proposed method are:

A) Dynamic pricing: the price is calculated based on the most recent information.

B) Granularity: The price can be calculated for any possible inventory profile.

C) Seasonality: Historical and forecasted future seasonality can be incorporated.

D) price response: the price changes with the current market conditions that are monitored closely through sell-through rate.

E) overall revenue: both GD and NGD revenue are taken care of by using NGD opportunity cost as a lower bound.

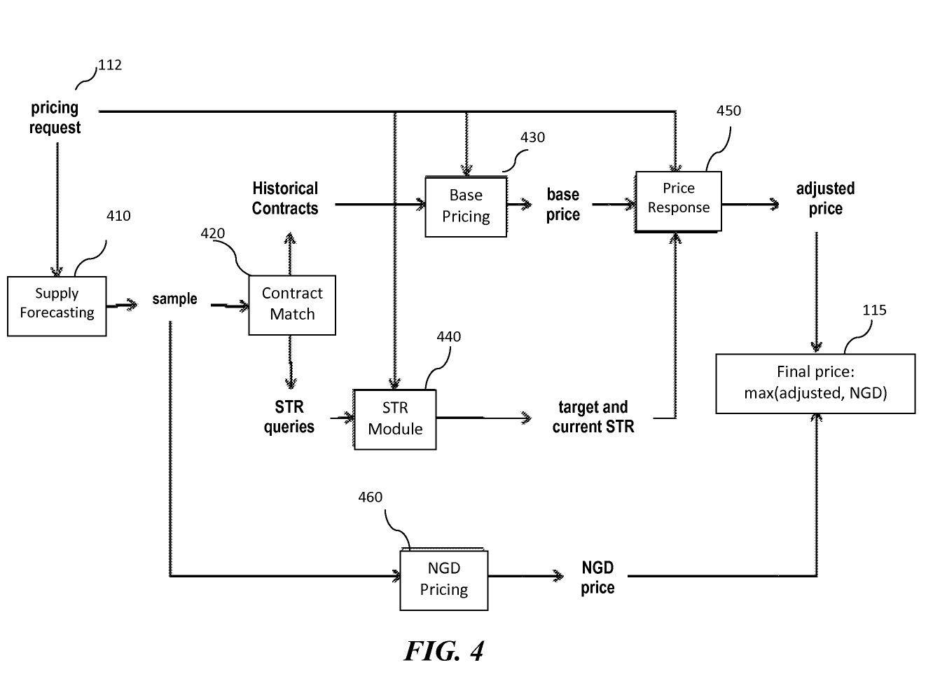

FIG. 4 shows the overall architecture of the dynamic pricing system. After receiving a pricing request 112, for example, “Dec. 1, 2011-Dec. 31, 2011, yahoo mail, LREC, male, age 35-45, living in Bay Area, interested in finance,” the system first calls Supply Forecasting 410 to get a sample of forecasted impressions that satisfy the request 112. Then Contract Match 420 matches each sample impression to a list of historical contracts that could be delivered with the impression. Base Pricing 430 calculates the base price with information from the matched historical contracts.

Each sample impression is also matched to a list of pre-defined typical queries (called STR queries), which are used to monitor the Sell-through-Rate (STR) that reflects the current market conditions through the STR Module 440. Price Response 450 decides to adjust the base price according to changes in market conditions. The adjusted price is finally compared with the NGD price forecasted by NGD Pricing 460 to make sure the final price 115 is no less than the opportunity cost from the NGD market.

STR is a useful tool to measure market conditions. It is defined as: 1 minus (the total available supply s₁ of a pricing request divided by the total eligible inventory S₁. The formula is shown here:

$${STR}_{r} = 1 - \frac{{s}_{r}}{{S}_{r}}$$

STR is influenced by pricing. In normal situations, higher price will lower the STR and lower price will raise the STR. Our dynamic pricing system is a feedback system that uses price to control the actual STR curve to be around a target STR curve. We ask: 1) what is the target STR? and 2) how to adjust the price.

Ideally, the target STR curve should be based on maximal revenue or profit. However, this would require the information of price elasticity of demand, which is very difficult to estimate given the high-dimensional inventory space. Instead we base the target STR on two sources: historical data and learned modeling. Historical data gives a reasonable reference while the learned modeling provides business insights regarding future supply and demand interactions.

We compare the current STR of a pricing request to its target STR. If the current STR is within a predefined range of the target STR, no price adjustment is needed. If the current STR is outside the range and higher (lower) than the target STR, the base price will be adjusted higher (lower) accordingly. The range for the target STR defines the responsiveness of the system and can be set based on the standard deviation of STR. The adjustment rate defines the aggressiveness and can be set to a fixed percentage or a value that changes with how far the current STR is from the target STR range and how close the query time is from the delivery time.

Historical STR shows a strong seasonal pattern in delivery time. For example, for some major properties and positions, the STR is low at the beginning of the year, but gradually picks up throughout the year and reaches its peak at the end of the year. When the target STR of a lead time is set to the average of historical STR for the same lead time, the seasonality in the historical STR will guide the price seasonality in a natural way. For example, for a pricing request with delivery time in the beginning of a year, its current STR will usually be lower than the target STR, resulting in a down adjustment of price; while the price of a pricing request to be delivered at the year-end will be adjusted higher because its current STR will usually be higher than the target STR.

As it is impossible to keep track of STR of all possible inventory profiles, we monitor a list of typical inventory profiles (called STR queries) that cover most of the revenue. Contract Match 420 matches an incoming pricing request to the STR queries whose STR will be used to estimate the STR of the pricing query 112.

### Hardware Embodiment

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium.

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

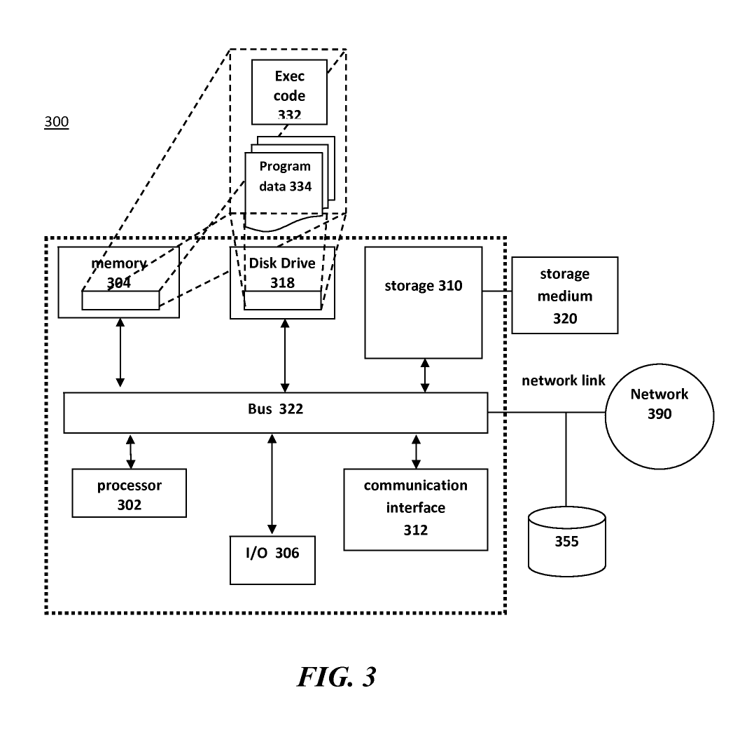

Referring now to FIG. 3, there is provided a simplified block illustration of an information processing system, such as the Dynamic Pricing Engine 150 in which the present invention may be implemented. For purposes of this invention, Engine 150 may represent any type of computer, information processing system or other programmable electronic device capable of storing digital media, such as a client computer, a server computer, a portable computer, an embedded controller, a personal digital assistant, table computer, Internet TV, cloud-enabled computing, and so on. The computer system 150 may be a stand-alone device or networked into a larger system. Computer system 150, illustrated for exemplary purposes as a networked computing device, is in communication with other networked computing devices (not shown) via network 390. As will be appreciated by those of ordinary skill in the art, network 390 may be embodied using conventional networking technologies and may include one or more of the following: local area networks, wide area networks, intranets, public Internet, Cloud computing, and the like.

Computer system 150 includes processing device 302 which communicates with memory 304, disk drive 318, storage 310, I/O subsystem 306, and a communications subsystem 312. The processor device 302 is connected to a communication infrastructure 322 (e.g., a communications bus, cross-over bar, or network). The processor device 302 may be a general or special purpose microprocessor operating under control of computer program instructions executed from memory 304. The processor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. The memory 304 may be partitioned or otherwise mapped to reflect the boundaries of the various memory subcomponents.

Memory 304 includes both volatile and persistent memory for the storage of: operational instructions for execution by CPU 302, data registers, application storage and the like. Memory 304 preferably includes a combination of random access memory (RAM), read only memory (ROM) and persistent memory such as that provided by a hard disk drive 318. The computer instructions/applications stored in memory 304 and executed by processor 302.

The I/O subsystem 306 may comprise various end user interfaces such as a display, a keyboards, and a mouse. The I/O subsystem 306 may further include a connection to a network such as a local-area network (LAN) or wide-area network (WAN) such as the Internet. Input devices may include, for example, a keyboard, a mouse, a scanner, an imaging system (e.g., a camera, etc.) or the like. Similarly, output devices may include displays, information display unit printers and the like. Additionally, combination input/output (I/O) devices may also be in communication with processing system 302. Examples of conventional I/O devices include removable and fixed recordable media (e.g., floppy disk drives, tape drives, CD-ROM drives, DVD-RW drives, etc.), touch screen displays and the like.

The computer system also includes a main memory 304, preferably random access memory (RAM), and may also include a secondary memory. The secondary memory may include, for example, a hard disk drive 318 and/or a removable storage drive 320, representing a floppy disk drive, a magnetic tape drive, an optical disk drive, DVD-ROM, etc. The removable storage drive 318 reads from and/or writes to a removable storage unit 320 in a manner well known to those having ordinary skill in the art. As will be appreciated, the removable storage unit 320 includes a computer readable medium having stored therein computer software and/or data.

The computer system may also include a communications interface 312. Communications interface 312 allows software and data to be transferred between the computer system and external devices. Examples of communications interface 312 may include a modem, a network interface (such as an Ethernet card), a communications port, a PCMCIA slot and card, etc.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for dynamic pricing in a guaranteed display market, comprising:
using a processor device, performing steps of:
receiving attribute parameters and values of an incoming pricing query for an advertisement, from an advertiser;
calculating a base price for the advertisement using recent historical information from contracts matching the attribute parameters and values;
calculating a price response by adjusting the base price to reflect market conditions;
calculating a non-guaranteed display opportunity cost for the adjusted base price; and
calculating a final price as a function of the adjusted base price and the non-guaranteed display opportunity cost, wherein said non-guaranteed display opportunity cost is a lower bound for the final price.

2. The method of claim 1 further comprising an initial step of:
receiving the incoming pricing query.

3. The method of claim 1 further comprising:
monitoring sell-through-rate to determine the market conditions.

4. The method of claim 1 further comprising:
providing the final price to the advertiser.

5. The method of claim 1 further comprising:
storing the final price.

6. The method of claim 1 wherein calculating the base price further comprises adjusting a historical price by seasonal trends.

7. The method of claim 6 wherein adjusting the historical price by seasonal trends comprises forecasting said seasonal trends in the future.

8. The method of claim 6 wherein adjusting the historical price by seasonal trends comprises adjusting the historical price by a current seasonal trend.

9. An information processing system for pricing advertisements in a guaranteed display market, comprising:
a memory with computer-executable instructions stored therein, said instructions comprising:
receiving attribute parameters and values of an incoming pricing query for an advertisement, from an advertiser;
calculating a base price for the advertisement using recent historical information from contracts matching the attribute parameters;
calculating a price response by adjusting the base price to reflect market conditions;
calculating a non-guaranteed display opportunity cost for the adjusted base price; and
calculating an advertisement price as a function of the adjusted base price and the non-guaranteed display opportunity cost, wherein said non-guaranteed display opportunity cost is a lower bound for the advertisement price; and
a processor device operably coupled with the memory.

10. The information processing system of claim 9 wherein the computer-executable instructions further comprise an initial step of:
receiving the incoming pricing query.

11. The information processing system of claim 9 wherein the computer-executable instructions further comprise:
monitoring sell-through-rate to determine the market conditions.

12. The information processing system of claim 9 wherein the computer-executable instructions further comprise:
providing the advertising price to the advertiser.

13. The information processing system of claim 9 wherein the computer-executable instructions further comprise:
storing the advertising price.

14. The information processing system of claim 9 wherein the computer-executable instructions further comprise:
calculating the base price by adjusting the historical price by seasonal trends.

15. The information processing system of claim 14 wherein the computer-executable instructions further comprise:
adjusting the historical price by forecasting the seasonal trends in the future.

16. The information processing system of claim 14 wherein the computer-executable instructions further comprise:
adjusting the historical price by a current seasonal trend.

17. A computer program product comprising a non-transitory computer-readable storage medium with computer-executable instructions stored therein for pricing advertisements in a guaranteed display market, said computer-executable instructions comprising:
receiving attribute parameters and values of an incoming pricing query for an advertisement, from an advertiser;
calculating a base price for the advertisement using recent historical information from contracts matching the attribute parameters;
calculating a price response by adjusting the base price to reflect market conditions;
calculating a non-guaranteed display opportunity cost for the adjusted base price; and
calculating a final price as a function of the adjusted base price and the non-guaranteed display opportunity cost, wherein said non-guaranteed display opportunity cost is a lower bound for the final price.

18. The computer program product of claim 17 wherein the computer-executable instructions further comprise:
monitoring sell-through-rate to determine the market conditions.

19. The computer program product of claim 17 wherein calculating the base price further comprises adjusting the historical price by seasonal trends.

20. The computer program product of claim 19 wherein adjusting the historical price further comprises identifying the seasonal trends that can affect the historical price.
